(19) United States
(12) Patent Application Publication
(10) Pub. No.: US 2006/0026109 A1
(43) Pub. Date: Feb. 2, 2006

(54) Mail handling terminal making it possible to track the content of the mail

(76) Inventor: Marek Krasuski, Fontenay-Aux-Roses (FR)

Correspondence Address: PERMAN & GREEN, 425 POST ROAD, FAIRFIELD, CT, 06824, US

(21) Appl. No.: 11/189,106

(22) Filed: Jul. 25, 2005

(30) Foreign Application Priority Data
Jul. 28, 2004 (FR) FR 04 08327

(51) Int. Cl. G06F 17/00

(52) U.S. Cl. 705/410

(57) ABSTRACT

A mail handling terminal including means for affixing, on a mail item, firstly a postal mark obtained in the terminal on the basis of determined postal data and secondly a unique identity number obtained in the terminal, and digital reader means for reading, off the mail item, firstly the destination address and secondly a sequential identity code disposed in the vicinity of the destination address, and for converting the destination address and the sequential identity code into a determined format enabling them to be stored in a tracking database in which the postal data and the unique identity number associated with the mail item are also stored, means further being provided for communicating a determined portion of the tracking database to a remote computer server via a secure communications network. The unique identity number is advantageously obtained on the basis of an enciphered combination of the sequential identity code and of the postal data.

### TECHNICAL FIELD

The present invention relates to the field of mail handling, and it relates more particularly to a mail handling system making it possible to establish a relationship between the postal or other data printed on a mail item and the data contained in said mail item.

### PRIOR ART

Conventionally, mail items that are to be handled by postal administrations are provided with postal imprints which, in the most recent standards, can be of complex form (two-dimensional (2D) bar codes) in order to increase the density of information that is printed on mail items and that relates not only to sending and sorting the mail items but also to tracking them, extracting added value from them, or making them secure, in particular. The increasing amount of such information could encourage postal administrations to replace the printed postal imprint with an electronic indicator or “radio-frequency identity (RFID) tag” stuck to the mail item and incorporating all of such information. Unfortunately, neither the postal imprint nor the RFID tag can be a medium for conveying data relating to the content of the mail item on which the postal imprint is printed or on which the RFID tag is stuck. Consequently, it is not possible for the user to track the mail item by reference to the content of said mail item.

Therefore, there is a currently-unsatisfied need for a mail handling system that enables the user to establish a relationship between the postal mark printed on or stuck to the mail item and the content of said mail item.

### OBJECT AND DEFINITION OF THE INVENTION

An object of the present invention is to mitigate that drawback by providing a mail handling terminal comprising means for affixing, on a mail item, firstly a postal mark obtained in said terminal on the basis of determined postal data and secondly a unique identity number obtained in said terminal, said mail handling terminal further comprising digital reader means for reading, off the mail item, firstly the destination address and secondly a sequential identity code disposed in the vicinity of said destination address, and for converting said destination address and said sequential identity code into a determined format enabling them to be stored in a tracking database in which said postal data and said unique identity number associated with the mail item are also stored, means further being provided for communicating a determined portion of said tracking database to a remote computer server via a secure communications network.

Thus, by such recognition of the sequential identity code and by it being stored in the tracking database, it is possible to associate the postal data generated in the terminal with data relating to the content of the mail item and generated at the time of creation of the documents enclosed in said mail item, and to transmit said associated data to a remote network.

Preferably, said determined portion of the tracking database includes at least information necessary for checking that the postage amount or the carriage has been paid, and for externally tracking said mail item.

Said digital reader means and said means for affixing said postal mark and said unique identity number may be formed by common RFID tag read/write means. Said postal mark and said unique identity number are then recorded by said RFID read/write means in an RFID tag stuck on or in the mail item or on a label for sticking onto the mail item.

When said postal mark is a postal imprint, said means for affixing said postal mark then comprise digital printer means for printing said postal imprint on the mail item or on a label for sticking onto the mail item, and said unique identity number is advantageously a series of alphanumeric characters, preferably of the OCR type, or a bar code, obtained on the basis of an enciphered combination of said sequential identity code and of said postal data, and printed by said digital printer means on the mail item or on a label for sticking onto the mail item.

Preferably, said digital reader means are removable in order to make it possible to read the destination addresses and the unique identification numbers borne by thick envelopes or parcels that cannot be inserted into said terminal.

The invention also provides a method of franking mail items, which method consists in affixing on a mail item both a postal mark obtained on the basis of determined postal data, and also a unique identity number, said method further consisting in reading, off said mail item, both a destination address and also a sequential identity code disposed in the vicinity of said destination address, and in converting said destination address and said sequential identity code into a determined format enabling it to be stored in a tracking database in which said postal data and said unique identity number associated with said mail item are also stored, a determined portion of the information stored in said tracking database being transmitted to a remote computer server prior to sending the mail item to the postal administration.

Preferably, said unique identity number is obtained on the basis of an enciphered combination of said sequential identity code and of postal data.

Depending on the implementation, said postal mark may be a postal imprint and the read step then includes digitizing said destination address and said sequential identity code disposed in the vicinity of said destination address, or else said postal mark may be an RFID tag, and said read step then includes successively reading said destination address and said sequential identity code as written in said RFID tag.

### BRIEF DESCRIPTION OF THE DRAWINGS

Other characteristics and advantages of the present invention appear more clearly from the following description given by way of non-limiting indication and with reference to the accompanying drawings, in which:

FIG. 1 shows an example of architecture of a mail handling system of the invention; and

FIG. 2 is a flow chart showing the various steps in operation of the system of FIG. 1.

### DETAILED DESCRIPTION OF A PREFERRED EMBODIMENT

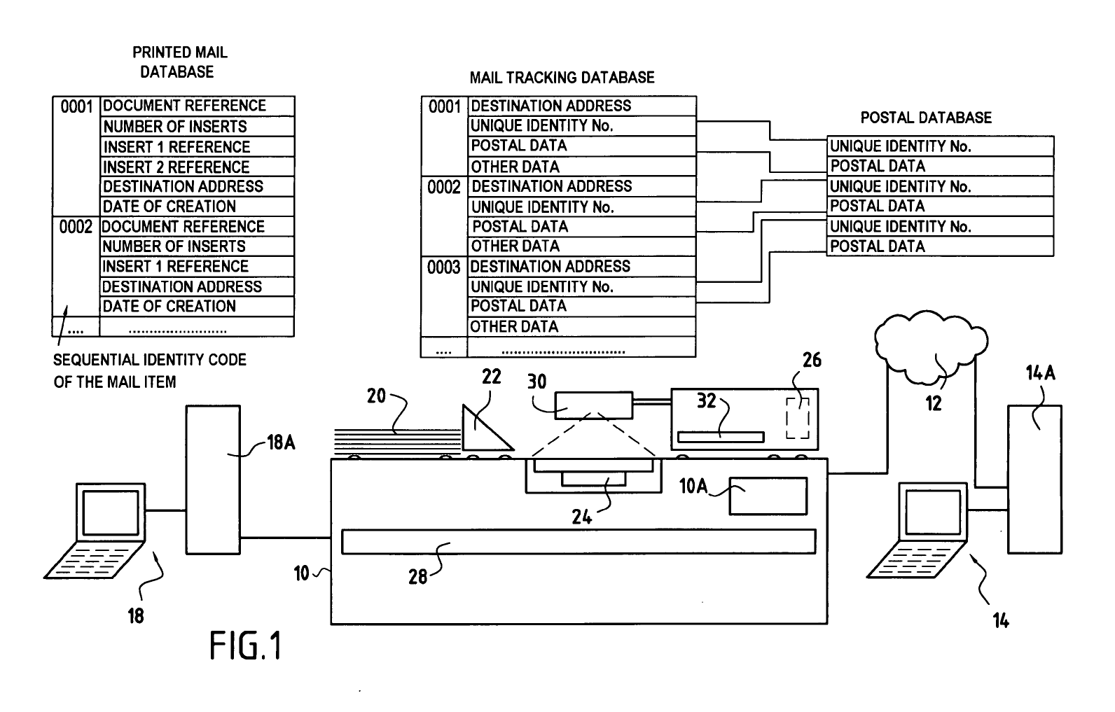

FIG. 1 diagrammatically shows the architecture of an electronic system of the invention for handling mail items. The term “mail item” is used to cover both an envelope (of any format) and a label for subsequently sticking to a thick envelope or a parcel.

This mail handling system includes a terminal 10 for handling mail items that is connected firstly via a wired or wireless external communications network 12 to a computer server 14 of the terminal distributor, and secondly via a dedicated line to a computer server 18 of the user.

A user computer server 18 can be constituted by a single computer or by a set of computers organized around an internal network and provided with common resources, in particular a database 18A. The database is a database containing printed mail data that is fed to the database at the time the documents for sending are created and by the computer(s) on which said documents are prepared. Initially, for each mail item to be sent, referenced by a sequential identity code (serial number in the database), the database contains at least the following fields: the reference of the document contained in the mail item, the reference(s) of any inserts to be enclosed with the document, and the destination address. Other information can be added to the database, such as (without the list being exhaustive): the date of creation of the document; the name or the personal number of the sender or the department concerned by the mail item; the desired postal service; or indeed an additional descriptive field. The database can be searched and indexed on the basis of each of said fields.

The distributor computer server 14 is a computer server including, as is known, conventional software means making it possible to issue an installation authorization, to check payment of postage amounts or of “franking”, to perform any renewal of postal credit, to check enciphering data, to manage customer accounts, and to perform statistical monitoring, e.g. via a customer database. Remote maintenance or on-line purchases, in particular payment of carriage paid, are also possible with such a computer structure. It should be noted that the distributor server can be connected to a server of the postal administration by a dedicated line and that, under certain operating conditions, the postal administration server can be connected directly to the terminal and thus used in place of distributor server for performing all of the above-mentioned operations.

The mail handling terminal is a machine with communications facilities of design similar to a conventional postage meter of the closed type, i.e. conventionally comprising (without the following list being limiting): feed means 20 for feeding in mail items, selection means 22 for selecting the mail items one-by-one, optionally means 24 for determining the format and/or the weight of the selected mail item, secure means for affixing a postal mark (or any other inscription, such as “carriage paid” in compliance with the postal specifications) on the mail item (e.g. digital printer means 26), and conveyor means 28 for conveying the mail item through the terminal. Naturally, the terminal also has interface means (not shown, of the modem or wireless communications type) for interfacing with the communications network 12 and the dedicated line, interface means (not shown) for interfacing with the user, e.g. of the screen and keypad type, and processor means (not shown but more particularly having memory and a microprocessor) for monitoring and controlling the terminal.

In the invention, the terminal further comprises digital reader means for reading the destination address of each of the various mail items and converting it into a determined format making suitable storage possible. In a first embodiment, said digital reader means, which are formed by a digitizer and associated software recognition means 30, are advantageously disposed after the individual selection means 22 for individually selecting the mail items and preferably above the means 24 for determining format and/or weight, when the terminal is provided with such means. In certain countries, the amount of the postage can be determined on the basis merely of the dimensions of the mail item, without taking account of its weight. Conversely, in France, for example, it is essential to weigh the mail item in order to determine the amount of the postage. However, directly inputting the postage amount on the keypad of the terminal avoids the need to determine the format and/or the weight of the mail item to be franked.

When the mail item is provided with an RFID tag, the digital reader means are advantageously formed by RFID tag read/write means 32 also preferably disposed after the mail item individual selection means 22 and which, in the second embodiment, can also act as means for affixing the postal mark.

Advantageously, the digital reader means (digitizer 30 or RFID tag read/write means 32) can be removable in order to make it possible to read labels for sticking onto very thick envelopes (and thus that cannot be inserted into the terminal) or onto parcels. The link between the reader means and the terminal can then be of the wired type or of the wireless type.

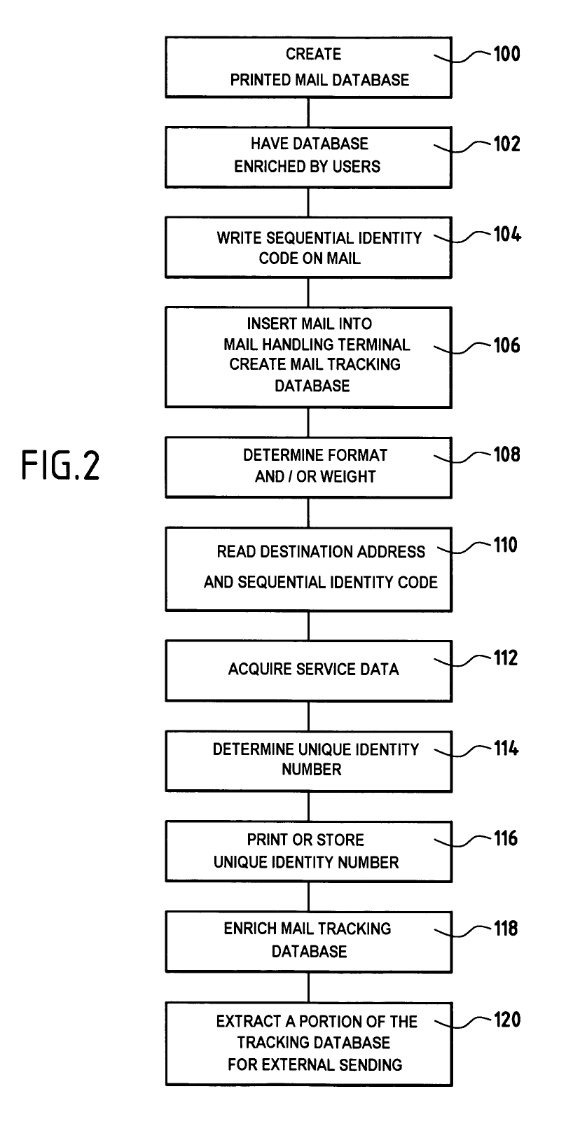

The method implemented in the mail handling system of FIG. 1 is explained below with reference to the flow chart of FIG. 2.

The first step 100 in the method consists in creating the mail item database 18A, which database is then enriched by users (step 102) as documents for sending are created. Recording in the database takes place sequentially per mail item, a sequential identity code being initially allocated to each mail item. Said code is then printed (step 104) preferably in the form of a bar code, as close as possible to the destination address, directly on the document before it is inserted into the envelope, on the envelope itself, or merely on a self-adhesive label (this applying to parcels). When the document or the envelope is provided with an RFID tag, the code is stored in said RFID tag.

The resulting information-bearing envelopes can then, in a following step 106, be inserted into the terminal 10 so that, after individual selection by the means 22, they can be subjected to the process of marking and/or franking. This process starts with a step 108 for determining the format and/or the weight of the mail item to be franked. Then, in a step 110, the destination address is read by one of the reader means 30 or 32 depending on the type of marking used, as is the sequential identity code. In parallel or previously, in a step 112, the terminal acquires the data relating to the services requested by the user and as input on the keypad of the terminal or as received by dedicated line, or else as contained in the RFID tag when such a tag exists.

On the basis of these elements, and in a step 114, the processor means 28 of the terminal generate the postal data in conventional manner, including the amount of the postage, and also a unique identity number that is advantageously obtained from the sequential identity code allocated to the mail item for sending and from some of said postal data relating to said mail item, typically a concatenated combination of: the postal number of the terminal; the postage amount and the date of franking; the number of the office from which the mail is to be posted; and the sequential item number, for example, without this data being limiting (it is possible to add elements of the destination address or the number of a department associated with said mail item or indeed non-postal data such as real-time date and time stamping data). The identity number is then printed with the postal imprint in a step 116, inside said postal imprint or in the vicinity thereof, in the form of digital or alphanumeric characters, preferably readable by an optical character recognition (OCR) reader, or else in the form of a one-dimensional (1D) or two-dimensional (2D) bar code that is readable with a suitable one-dimensional or two-dimensional bar code reader. When the document or the envelope bears an electronic indicator of the RFID tag type, the identity number is stored in said indicator by the read/write means 32 as is the other postal data.

Simultaneously or subsequently, in a step 118, a tracking database 10A associated with the terminal is enriched, which tracking database was created earlier, e.g. when the terminal was switched on for the first time or when the first mail item was inserted into the terminal in step 106. The tracking database can be stored in the memory means of the processor means 28 of the terminal or independently therefrom outside the terminal, e.g. at common resources of the user computer means, which common resources are accessible via a dedicated line. The tracking database has a large number of fields, naturally with all of the usual postal data (amount and date of franking, postal number of the franking terminal or postage meter, name and number of the office from which the mail is to be posted, sequential mail item number, etc.) and also with all of the information relating to one or more services requested by the user (registered or recorded-delivery, name of carrier, etc.) as well as any other data necessary or useful for mail handling by the postal administration (reception, tracking, delivery). But above all, the tracking database includes the sequential identity code that makes it possible to associate the mail item with its content stored in the database 18A of the printed mail items. Naturally, the tracking database also includes security information making it possible for the distributor server 14 to authenticate the postal data and other information contained in the tracking database. In a last step 120, information is extracted from the tracking database that is necessary for checking that the user has paid the franking (i.e. the postage amount) or the carriage in the event that the mail item is sent “carriage paid” and for externally tracking said mail item, so that said information can be sent to the terminal distributor via the communications network 12. This secure communication takes place prior to sending the mail item to the postal administration (possibly after a plurality of successive attempts in the event of failure to establish communication). When the mail item bears an RFID tag, it is also possible to store said information directly in said tag.

Thus, when a mail item is received at a reception office of the postal administration, the unique identity number is input automatically (by an OCR, bar code, or RFID tag read device, depending on the type of marking used), (said unique identity number possibly then being deciphered if it has undergone prior enciphering), and said unique identity number then gives access to the various associated fields of the tracking database. The logistics system of the postal administration can then handle said mail item in compliance with the services requested by the user-sender, and optionally return various kinds of tracking information relating to the handled mail item to the distributor server and/or make such tracking information available to the user via suitable input means such as input at the Internet site of the postal administration.

Naturally, the above-described individual mail handling system can also operate as a batch handling system of the “manifest” type.

What is claimed is:

1. A mail handling terminal comprising means for affixing, on a mail item, firstly a postal mark obtained in said terminal on the basis of determined postal data and secondly a unique identity number obtained in said terminal, said mail handling terminal further comprising digital reader means for reading, off the mail item, firstly the destination address and secondly a sequential identity code disposed in the vicinity of said destination address, and for converting said destination address and said sequential identity code into a determined format enabling them to be stored in a tracking database in which said postal data and said unique identity number associated with the mail item are also stored, means further being provided for communicating a determined portion of said tracking database to a remote computer server via a secure communications network.

2. A mail handling terminal according to claim 1, wherein said determined portion of the tracking database includes at least information necessary for checking that the postage amount or the carriage has been paid, and for externally tracking said mail item.

3. A mail handling terminal according to claim 1, wherein said digital reader means and said means for affixing said postal mark and said unique identity number are formed by common RFID tag read/write means.

4. A mail handling terminal according to claim 3, wherein said postal mark and said unique identity number are recorded by said RFID read/write means in an RFID tag stuck on or in the mail item or on a label for sticking onto the mail item.

5. A mail handling terminal according to claim 1, wherein said postal mark is a postal imprint and said means for affixing said postal mark comprise digital printer means for printing said postal imprint on the mail item or on a label for sticking onto the mail item.

6. A mail handling terminal according to claim 5, wherein said unique identity number is a series of alphanumeric characters, preferably of the OCR type, or a bar code, obtained on the basis of an enciphered combination of said sequential identity code and of said postal data, and printed by said digital printer means on the mail item or on a label for sticking onto the mail item.

7. A mail handling terminal according to claim 1, wherein said digital reader means are removable in order to make it possible to read the destination addresses and the unique identification numbers borne by thick envelopes or parcels that cannot be inserted into said terminal.

8. A method of franking mail items, which method consists in affixing on a mail item both a postal mark obtained on the basis of determined postal data, and also a unique identity number, said method further consisting in reading, off said mail item, both a destination address and also a sequential identity code disposed in the vicinity of said destination address, and in converting said destination address and said sequential identity code into a determined format enabling it to be stored in a tracking database in which said postal data and said unique identity number associated with said mail item are also stored, a determined portion of the information stored in said tracking database being transmitted to a remote computer server prior to sending the mail item to the postal administration.

9. A method according to claim 8, wherein said unique identity number is obtained on the basis of an enciphered combination of said sequential identity code and of postal data.

10. A method according to claim 8, wherein said postal mark is a postal imprint and wherein the read step includes digitizing said destination address and said sequential identity code disposed in the vicinity of said destination address.

11. A method according to claim 8, wherein said postal mark is an RFID tag, and wherein said read step includes successively reading said destination address and said sequential identity code as written in said RFID tag.
